(19) United States
(12) Patent Application Publication
(10) Pub. No.: US 2026/0030904 A1
(43) Pub. Date: Jan. 29, 2026

(54) PIPELINE FOR LABELING DATA

(71) Applicant: Future Artificial Intelligence LLC, Albuquerque, NM (US)

(72) Inventor: Dongjun Cai, Wenchang City (CN)

(21) Appl. No.: 19/099,366

(22) PCT Filed: Oct. 6, 2023
(86) PCT No.: PCT/US2023/076261

§ 371 Date: Jan. 28, 2025

Related U.S. Application Data
(60) Provisional application No. 63/415,898, filed on Oct. 13, 2022.

(51) Int. Cl. G06V 20/70; G06N 3/045; G06N 3/08; G06T 5/20; G06V 10/25; G06V 10/82

(52) U.S. Cl. CPC G06V 20/70; G06N 3/045; G06N 3/08; G06T 5/20; G06V 10/25; G06V 10/82; G06T 2207/20132

(57) ABSTRACT

The systems and methods disclosed herein provide a computer system, the computer system configured for receiving a plurality of images, selecting an area of at least of the images defined by a bounding box, cropping the selected areas from the images and storing the cropped images in folders, filtering incorrectly identified objects, generating pseudo labels for the remaining images, and assigning correct item names for the pseudo labels.

### CROSS REFERENCE TO RELATED PATENT APPLICATIONS

This application claims the priority and benefit under 35 U.S.C. § 119 (e) of U.S. Provisional Patent Application Ser. No. 63/415,898, filed Oct. 13, 2022, entitled “PIPELINE FOR LABELING DATA.” U.S. Provisional Patent Application Ser. No. 63/415,898 is herein incorporated by reference in its entirety.

### TECHNICAL FIELD

Embodiments are generally related to the field of computers. Embodiments are also related to the field of machine learning. Embodiments are further related to the field of image labeling. Embodiments are further related to the field of training neural networks. Embodiments are further related to the field of computer devices and mobile devices used for labeling data. Embodiments are also related to methods, systems, and devices for machine learning. Embodiments are further related to method and systems for labeling image data with a computer.

### BACKGROUND

With the advent of mobile devices, consumers have unprecedent access to image generating equipment. The number of photographs taken every day is approximated to be 4.7 billion, a nearly 3 fold increase over the number taken in 2013. Experts expect this trend to continue. This has created a massive catalogue of image data, which is growing all the time.

This library of photographs offers an as yet underutilized source of data which could be used for science, engineering, business, education, and myriad other applications. Among the chief challenges to harnessing the power of this data, is a way to systematically label the data in order to make it more searchable. Likewise, advances in the technology underlying machine learning have led to a high demand for image labeling.

There are currently a number of methods available for labeling data. For example, Google® Offers an image labeling service known as the “AI PLATFORM DATA LABELING SERVICE”, which is a paid service where a human labels a collection of data. These services range in price, but the bottleneck in such methods is the means by which an aspect of the image is selected, bounded, and then labeled. This type of labeling is cumbersome and unnecessarily expensive. However, it is also critically important to machine learning algorithms, which require training data to function properly.

Accordingly, there is a need in the art for methods and systems for pipeline data labeling, as disclosed in the embodiments described herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide improved methods and systems for image labeling.

It is another aspect of the disclosed embodiments to provide a method, system, and apparatus for labeling image data with a computer.

It is another aspect of the disclosed embodiments to provide methods, systems, and apparatuses for labeling training data for machine learning.

For example, in certain embodiments, the systems and methods disclosed herein comprise a computer system, the computer system configured for receiving a plurality of images, selecting an area of at least of the images defined by a bounding box, cropping the selected areas from the images and storing the cropped images in folders, filtering incorrectly identified objects, generating pseudo labels for the remaining images, and assigning correct item names for the pseudo labels.

In an embodiment, a system comprises a computer system, the computer system further comprising at least one processor; a graphical user interface; and a computer-usable medium embodying computer program code, the computer-usable medium capable of communicating with the at least one processor, the computer program code comprising instructions executable by the at least one processor and configured for: receiving a plurality of images, selecting an area of interest in at least one of the images, defined by a bounding box, cropping the selected areas from the images and storing the cropped images in folders, filtering incorrectly identified objects, generating pseudo labels for the remaining images, and assigning correct item names for the pseudo labels. In an embodiment of the system, the plurality of images comprises at least one of an image file, a video file, and a video frame file. In an embodiment of the system, the computer program code comprising instructions executable by the at least one processor is further configured for identifying any of the plurality of images missing bounding boxes. In an embodiment of the system, the computer program code comprising instructions executable by the at least one processor is further configured for generating an annotation file corresponding to the plurality of images received. In an embodiment, the folders further comprises folder names corresponding to objects. In an embodiment of the system, the cropped images in the folders follow a file naming convention. In an embodiment of the system, the file naming convention comprises a file name of the type [ORIGINAL IMAGE NAME]-[LINE NUMBER IN ANNOTATION FILE]. In an embodiment of the system, the computer program code comprising instructions executable by the at least one processor is further configured for sorting cropped images by file size. In an embodiment of the system, the computer program code comprising instructions executable by the at least one processor is further configured for sorting cropped images by file name. In an embodiment of the system, the computer program code comprising instructions executable by the at least one processor is further configured for training a labeling neural network, wherein the trained labeling neural network is used to generate the pseudo labels for the remaining images. In an embodiment of the system, the computer program code comprising instructions executable by the at least one processor is further configured for training a classification neural network, wherein the trained classification neural network is used to assign the correct item names for the pseudo labels.

In another embodiment, a method comprises receiving a plurality of images, selecting an area of interest in at least one of the images defined by a bounding box, cropping the selected areas from the images and storing the cropped images in folders, filtering incorrectly identified objects, generating pseudo labels for the remaining images, and assigning correct item names for the pseudo labels. In an embodiment, the method further comprises identifying any of the plurality of images missing bounding boxes. In an embodiment, the method further comprises generating an annotation file corresponding to the plurality of images received. In an embodiment, the method further comprises sorting cropped images by file size and removing cropped images from incorrect folders. In an embodiment, the method further comprises sorting cropped images by file name and removing cropped images from incorrect folders. In an embodiment, the method further comprises training a labeling neural network, wherein the trained labeling neural network is used to generate the pseudo labels for the remaining images. In an embodiment, the method further comprises training a classification neural network, wherein the trained classification neural network is used to assign the correct item names for the pseudo labels.

In another embodiment, a system comprises a computer system, the computer system further comprising at least one processor; a graphical user interface; and a computer-usable medium embodying computer program code, the computer-usable medium capable of communicating with the at least one processor, the computer program code comprising instructions executable by the at least one processor and configured for receiving a plurality of images, selecting an area of interest in at least one of the images defined by a bounding box, cropping the selected areas from the images and storing the cropped images in folders, generating an annotation file corresponding to the plurality of images received, sorting cropped images by file size, removing cropped images from incorrect folders, sorting cropped images by file name, removing cropped images from incorrect folders, generating pseudo labels for the remaining images using a labeling neural network, and assigning correct item names for the pseudo labels using a classification neural network. In an embodiment of the system, the computer program code comprising instructions executable by the at least one processor is further configured for training a labeling neural network, wherein the trained labeling neural network is used to generate the pseudo labels for the remaining images and training a classification neural network, wherein the trained classification neural network is used to assign the correct item names for the pseudo labels.

### BRIEF DESCRIPTION OF THE FIGURES

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1 depicts a block diagram of a computer system which is implemented in accordance with the disclosed embodiments;

FIG. 2 depicts a graphical representation of a network of data-processing devices in which aspects of the present embodiments may be implemented;

FIG. 3 depicts a computer software system for directing the operation of the data-processing system depicted in FIG. 1, in accordance with an example embodiment;

FIG. 4A depicts, steps associated with a method for labeling images, in accordance with the disclosed embodiments;

FIG. 4B depicts, steps associated with a method for training a classifier, in accordance with the disclosed embodiments;

FIG. 5A depicts steps associated with a method for sorting and filtering image data, in accordance with the disclosed embodiments;

FIG. 5B depicts steps associated with a method for sorting and filtering image data, in accordance with the disclosed embodiments;

FIG. 6 depicts a block diagram of a system for labeling images, in accordance with the disclosed embodiments;

FIG. 7A depicts exemplary file names, in accordance with the disclosed embodiments;

FIG. 7B depicts exemplary folders, in accordance with the disclosed embodiments;

FIG. 8 depicts a process for sorting and filtering file data, in accordance with the disclosed embodiments;

FIG. 9 depicts exemplary steps in a computer implemented method for labeling images, in accordance with the disclosed embodiments; and

FIG. 10 depicts exemplary steps in a computer implemented method for training a neural network, in accordance with the disclosed embodiments.

### DETAILED DESCRIPTION

The particularities of the following descriptions are meant to be exemplary, and are provided to illustrate one or more embodiments and are not intended to limit the scope thereof.

Such exemplary embodiments are more fully described hereinafter, including reference to the accompanying drawings, which show illustrative embodiments. The systems and methods disclosed herein can be embodied in various ways and should not be construed as limited to the embodiments set forth herein. Specifications are provided so that this disclosure will be thorough and complete, and will fully convey the scope of the embodiments to those skilled in the art. Like reference numeral may refer to like elements throughout.

The terminology used herein is for the purpose of describing particular embodiments only and is not intended to be limiting. As used herein, the singular forms such as “a”, “an”, and “the” are intended to include plural forms as well, unless context clearly indicates otherwise. Likewise, the terms “comprise,” “comprises” and/or “comprising,” as used herein, specify the presence of stated features, integers, steps, operations, elements, and/or components, but do not preclude the presence or addition of other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope and concept of the invention as defined by the appended claims.

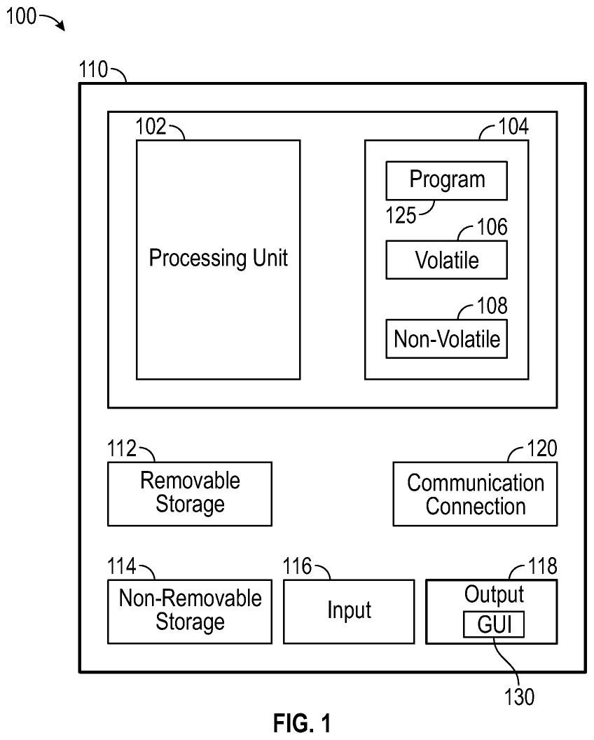

FIGS. 1-3 are provided as exemplary diagrams of data-processing environments in which embodiments of the present invention may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 100 that executes programming for implementing parts of the methods and systems disclosed herein is shown in FIG. 1. A computing device in the form of a computer 110 configured to interface with sensors, peripheral devices, and other elements disclosed herein may include one or more processing units 102, memory 104, removable storage 112, and non-removable storage 114. a processor or processing unit 102, as used herein, means one or more processors that perform the described functions, or a plurality of processors that perform the desired functions collectively amongst themselves, resulting in potentially dividing the described functions amongst the one or more processors to achieve a desired outcome. In certain embodiments, the processing units 102 can comprise one or more GPUs. Memory 104 may include volatile memory 106 and non-volatile memory 108. Computer 110 may include or have access to a computing environment that includes a variety of transitory and non-transitory computer-readable media such as volatile memory 106 and non-volatile memory 108, removable storage 112 and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data including image data.

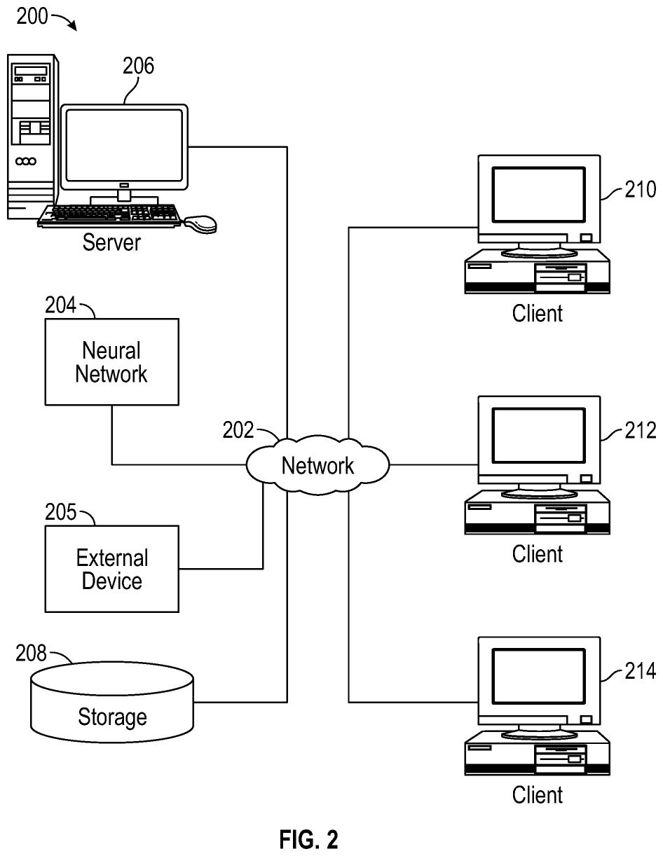

Computer 110 may include or have access to a computing environment that includes input 116, output 118, and a communication connection 120. The computer may operate in a networked environment using a communication connection 120 to connect to one or more remote computers, remote sensors, detection devices, hand-held devices, multi-function devices (MFDs), mobile devices, tablet devices, mobile phones, Smartphones, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 2 below.

Output 118 is most commonly provided as a computer monitor, but may include any output device. Output 118 and/or input 116 may include a data collection apparatus associated with computer system 100. In addition, input 116, which commonly includes a computer keyboard and/or pointing device such as a computer mouse, computer track pad, or the like, allows a user to select and instruct computer system 100. A user interface can be provided using output 118 and input 116. Output 118 may function as a display for displaying data and information for a user, and for interactively displaying a graphical user interface (GUI) 130.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 116 such as, for example, a pointing device such as a mouse and/or with a keyboard. A particular item can function in the same manner to the user in all applications because the GUI provides standard software routines (e.g., module 125) to handle these elements and report the user's actions. The GUI can further be used to display the electronic service image frames as discussed below.

Computer-readable instructions, for example, program module or node 125, which can be representative of other modules or nodes described herein, are stored on a computer-readable medium and are executable by the processing unit 102 of computer 110. Program module or node 125 may include a computer application. A hard drive, CD-ROM, RAM, Flash Memory, and a USB drive are just some examples of articles including a computer-readable medium.

FIG. 2 depicts a graphical representation of a network of data-processing systems 200 in which aspects of the present invention may be implemented. Network data-processing system 200 is a network of computers or other such devices such as mobile phones, smartphones, sensors, detection devices, and the like in which embodiments of the present invention may be implemented. Note that the system 200 can be implemented in the context of a software module such as program module 125. The system 200 includes a network 202 in communication with one or more clients 210, 212, and 214, and external device 205, which could be a computer, camera, or other such device. Network 202 may also be in communication with one or more RFID and/or GPS enabled devices or sensors, neural network 204, servers 206, and storage 208. Network 202 is a medium that can be used to provide communications links between various devices and computers connected together within a networked data processing system such as computer system 100. Network 202 may include connections such as wired communication links, wireless communication links of various types, fiber optic cables, quantum, or quantum encryption, or quantum teleportation networks, etc. Network 202 can communicate with one or more servers 206, one or more external devices such as RFID and/or GPS enabled device, or neural network 204, and a memory storage unit such as, for example, memory or database 208. It should be understood that RFID and/or GPS enabled device, or neural network 204 may be embodied as a module on a mobile device, cell phone, tablet device, monitoring device, detector device, sensor microcontroller, controller, receiver, transceiver, or other such device.

In the depicted example, RFID and/or GPS enabled device, neural network 204, server 206, and clients 210, 212, and 214 connect to network 202 along with storage unit 208. Clients 210, 212, and 214 may be, for example, personal computers or network computers, handheld devices, mobile devices, tablet devices, smartphones, personal digital assistants, microcontrollers, recording devices, MFDs, etc. Computer system 100 depicted in FIG. 1 can be, for example, a client such as client 210 and/or 212.

Computer system 100 can also be implemented as a server such as server 206, depending upon design considerations. In the depicted example, server 206 provides data such as boot files, operating system images, applications, and application updates to clients 210, 212, and/or 214. Clients 210, 212, and 214. RFID and/or GPS enabled device, and neural network 204 are clients to server 206 in this example. Network data-processing system 200 may include additional servers, clients, and other devices not shown. Specifically, clients may connect to any member of a network of servers, which provide equivalent content.

In the depicted example, network data-processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 200 may also be implemented as a number of different types of networks such as, for example, an intranet, a local area network (LAN), or a wide area network (WAN). FIGS. 1 and 2 are intended as examples and not as architectural limitations for different embodiments of the present invention.

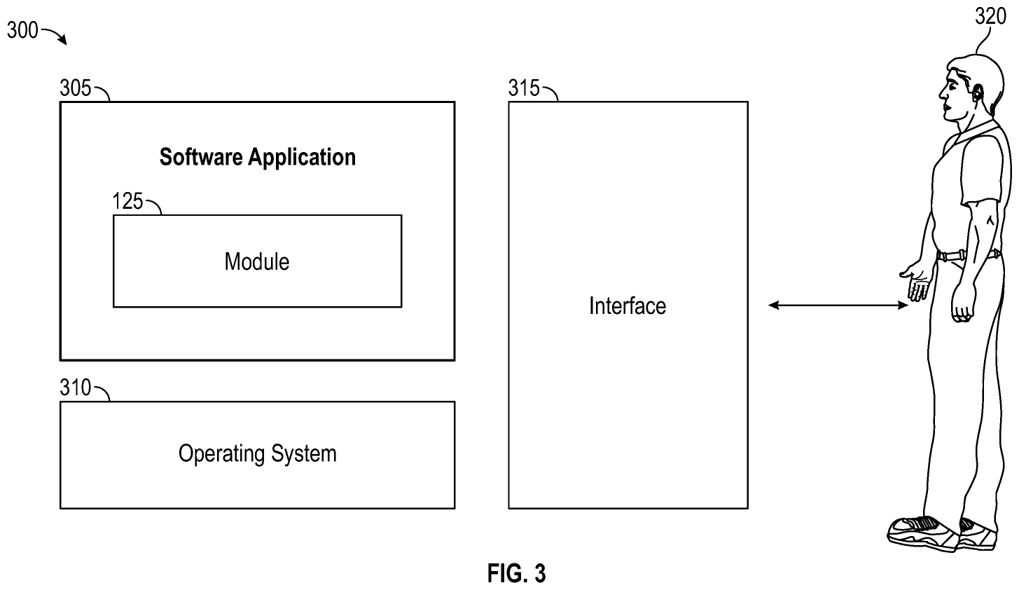

FIG. 3 illustrates a software system 300, which may be employed for directing the operation of the data-processing systems such as computer system 100 depicted in FIG. 1. Software application 305, may be stored in memory 104, on removable storage 112, or on non-removable storage 114 shown in FIG. 1, and generally includes and/or is associated with a kernel or operating system 310 and a shell or interface 315. One or more application programs, such as module(s) or node(s) 125, may be “loaded” (i.e., transferred from removable storage 112 into the memory 104) for execution by the data-processing system 100. The data-processing system 100 can receive user commands and data through user interface 315, which can include input 116 and output 118, accessible by a user 320. These inputs may then be acted upon by the computer system 100 in accordance with instructions from operating system 310 and/or software application 305 and any software module(s) 125 thereof.

Generally, program modules (e.g., module 125) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smart phones, tablet devices, multi-processor systems, printers, copiers, fax machines, multi-function devices, data networks, microprocessor-based or programmable consumer electronics, networked personal computers, minicomputers, mainframe computers, servers, medical equipment, medical devices, and the like.

Note that the term module or node as utilized herein may refer to a collection of routines and data structures that perform a particular task or implements a particular abstract data type. Modules may be composed of two parts: an interface, which lists the constants, data types, variables, and routines that can be accessed by other modules or routines; and an implementation, which is typically private (accessible only to that module), and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 315 (e.g., a graphical user interface 130) can serve to display results, whereupon a user 320 may supply additional inputs or terminate a particular session. In some embodiments, operating system 310 and GUI 130 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 310 and interface 315. The software application 305 can include, for example, module(s) 125, which can include instructions for carrying out steps or logical operations such as those shown and described herein.

The following description is presented with respect to embodiments of the present invention, which can be embodied in the context of, or require the use of a data-processing system such as computer system 100, in conjunction with program module 125, and data-processing system 200 and network 202 depicted in FIGS. 1-3. The present invention, however, is not limited to any particular application or any particular environment. Instead, those skilled in the art will find that the systems and methods of the present invention may be advantageously applied to a variety of system and application software including database management systems, word processors, and the like. Moreover, the present invention may be embodied on a variety of different platforms including Windows, Macintosh, UNIX, LINUX, Android, Arduino and the like. Therefore, the descriptions of the exemplary embodiments, which follow, are for purposes of illustration and not considered a limitation.

In the embodiments disclosed herein, a system, method, and apparatus can comprise aspects for training deep neural networks for object detection, segmentation, and 3D-objection detection, among other applications. Such methods require a lot of accurate labeling data. In general, a labeler labels an image, by drawing a bounding box/polygon/3D bounding box/3D-polygon or the like around an object that is to be detected and assigns a name from a category to that object.

The disclosed systems and methods are directed to labeling image data quickly and efficiently. This can be accomplished by drawing a correct bounding box/polygon/3D-bounding box/3D-polygon or the like around an object. Next, in a reviewing step, the labeling results are reviewed using reviewing software modules. The images are cropped, and all the cropped images identified in the labeling and reviewing process are put in folders. Using the disclosed sorting methods, a reviewer can then easily discover any incorrectly saved cropped image.

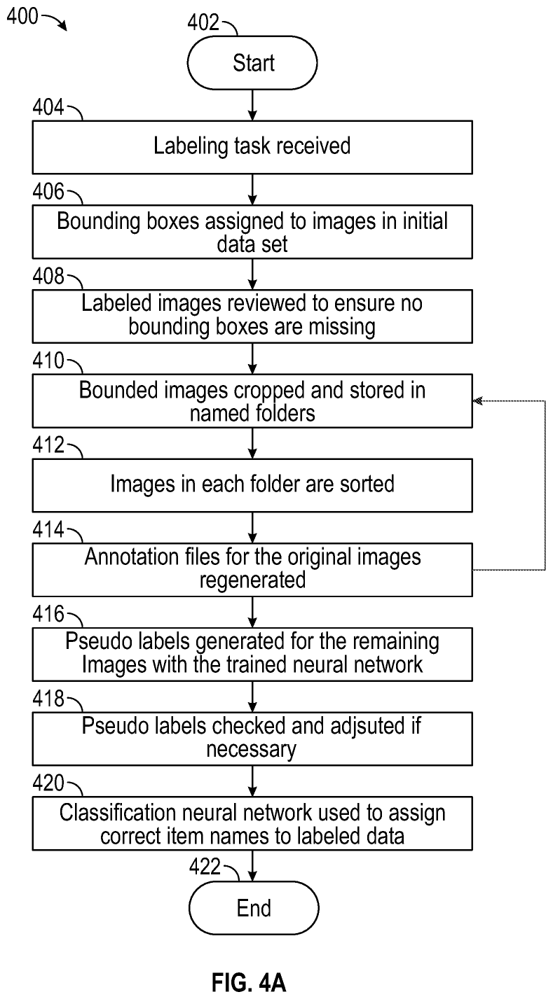

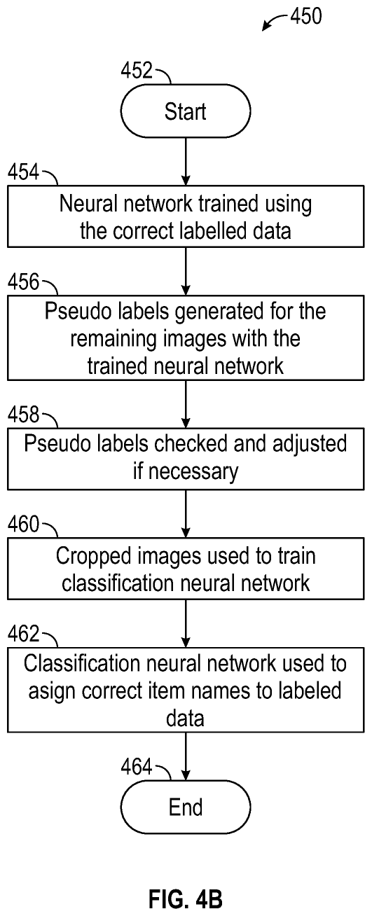

FIG. 4A illustrates a method 400 for labeling data in accordance with the disclosed embodiments. The method 400 starts at step 402. As illustrated at step 404 a labeling task and be assigned and then accepted. Generally, this includes the submission of a batch of one or more images as image data files, as well as an indication of the labeling criteria for the images. In certain embodiments, the labeling task can include labeling for an array of images, where one or more objects in the array of photographs is to be identified. For example, the labeling task could include an array of 20 photographs, video frames, or videos, and a request to identify or label an object such as “birds” in the image data comprising the array images, videos, or video frames.

Thus, as a preliminary step in the method 400, project data can be collected. This can include, for example, information indicating the objects to be identified in the images as well as provision of the images themselves. As an example, the number of images “I” can be provided by the customer or user. If the total number of possible labels L is known, the total can be provided by equation (1) as follows:

$$Total tasks = {I}^{*} L \qquad ( 1 )$$

Thus, if the number of images I is 10 and the total possible labels L is 500, the total number of required tasks is 5000. In certain embodiments, aspects of the labeling task can also be specified. For example, Table 1 illustrates options indicating the type of data, purpose of the task, and the type of bounding box as follows:

TABLE 1

| Type of Data | Task | Selection Style |
|---|---|---|
| Image | Bounding Box | Bounding Box |
| Image | Segmentation | Segment |
| Image | Rotated Box | Bounding Box |
| Image | Polygon/Polyline | Polygon |
| Video | Object tracking | Bounding Box |

Next at step 406 a bounding box/polygon/3D-bounding or other such bounding line, such as a box/3D-polygon can be drawn around an object of interest. In certain embodiments, this can be completed by human labelers, tasked with adding the bounding box to the images. In other embodiments, instead of using human labelers, available models can be used to provide bounding boxes/polygons/3D-bounding boxes/3D-polygons. For example, if a model is capable of labeling one category of image (e.g., humans in an image), the model can also be used to label other similar categories, (e.g., monkeys) if necessary.

In certain embodiments, the bounding boxes can be drawn by a human being using a bounding box drawing application provided by a labeling software module and associated GUI as further detailed herein. The system automatically assigns the first labeling term to the object and saves the result to an annotation file. Note, conventional wisdom would be to assign the correct item name to the object. However, if there are 100 items/objects, then the labeler would need to go through all the 100 items to find the correct name, which is very time consuming. Thus, in the present method the first item name or label is assigned to the object regardless of whether or not this is the correct item name.

Once the initial steps are complete, a reviewing procedure can commence. In the reviewing step 408 the image labeling can be reviewed to make sure that there are no missing bounding box/polygon/3D-bounding box/3D-polygon for all the images. This step is meant to ensure that a bounding box has been appropriately added to all files where appropriate.

Next, at step 410, a reviewer module can be used to crop the objects from the images and place them in corresponding folders whose names are the corresponding items' names. In certain embodiments, a file in the system, optionally named “classes.txt” (or other such name,) contains all the names of the items. In certain embodiments, aspects of this can be completed by a human being using a cropping application provided by a reviewer module and associated GUI.

When saving the cropped images of the objects, a review module can adopt a naming convention. The following is an exemplary naming convention, but it should be appreciated that other naming conventions can be used. In certain embodiments, the exemplary naming convention comprises: [original image name]-[line number in the annotation file].jpg.

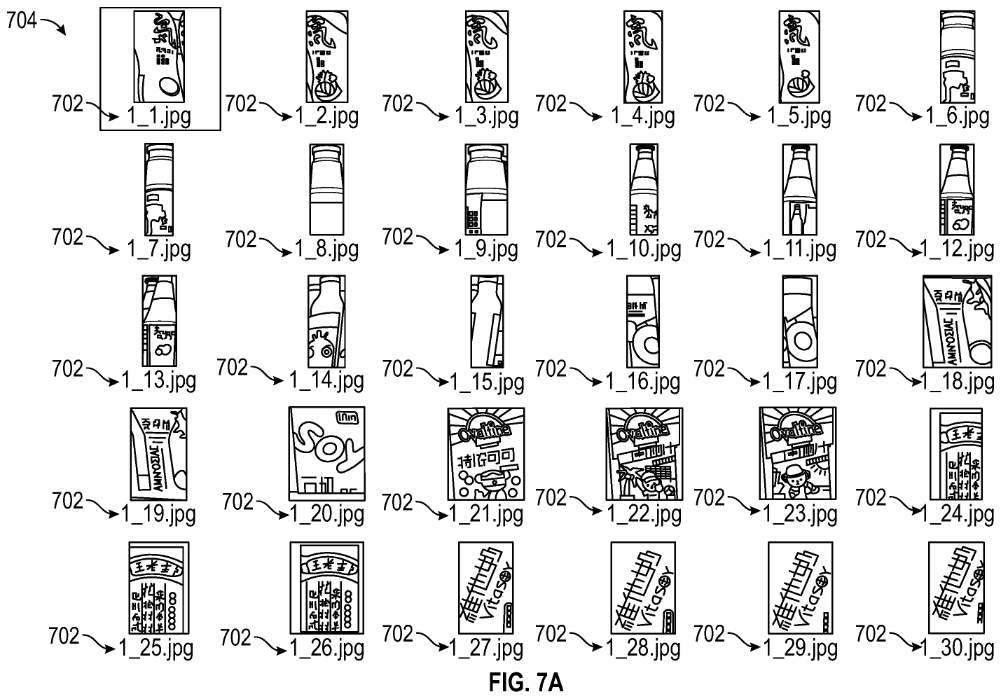

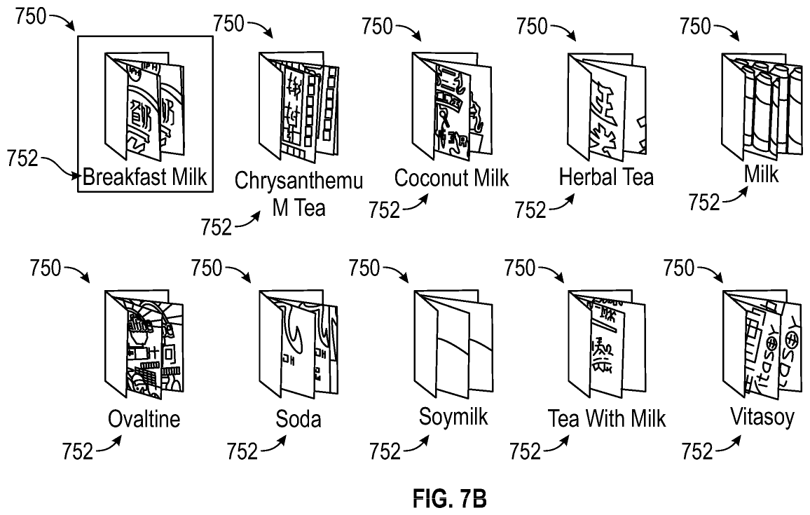

An example of this is illustrated in FIG. 7A which shows the file names 702 for an array of image data files 704, and FIG. 7B which illustrates the folders 750 with names 752 corresponding to item names. Note, the folder names 752 can correlate to the objects identified in the initial step as those aspects which require identification in the images. As illustrated by the exemplary annotation file, each line can have 5 numbers. The first one is the index number of the item. The index number is used to find the item name in the classes.txt file. The remaining 4 numbers give the information of the location of the bounding box in the image. When cropping the image, the reviewer module will read each line and crop the item image from the original image using the bounding box information. Thus, the names of the original images (as supplied by the customer or user) are the names given by the customer or user. However, for the cropped images, the name is nominally assigned as: [original image name]_[line number in the corresponding annotation file].jpg.

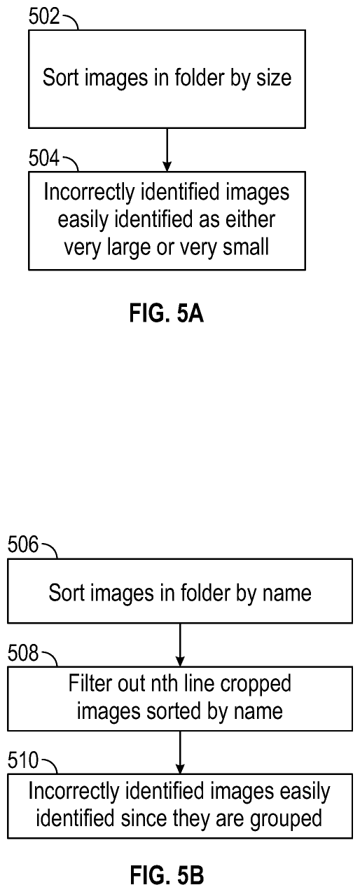

At step 412, images in each folder are sorted. In an embodiment, the sorting methods illustrated in FIGS. 5A and/or 5B can be used to sort the cropped images in each folder to make it easier to identity the misplaced cropped images or “false positive bounding box” at step 412.

As used herein the false positive bounding box refers to a bounding box with an item name in the original image, but where no object, or many objects, are in the bounding box. In such an example, the cropped image is a false positive image or false positive bounding box.

In certain aspects, as illustrated in FIG. 5A the cropped images in each folder can be sorted by the size of the cropped images at 502. False positive images often have a divergent sizes, e.g., they either are very large or very small as compared to other correctly labeled images. Sorting by size shifts those images which are likely to be incorrectly labeled to be either at the respective beginning or end of the sorted images. At step 504, this makes it very easy to identify such incorrectly identified images. Once the false positive images are detected, they can be easily deleted because they are either at the bottom or top in the sorting.

Next, as illustrated in FIG. 5B the images in the folder can be sorted by name at 506. The nth line cropped images are filtered out and sorted by the names at step 508. For example, in many cases, the images from clients are from videos and they are named as: 1.jpg, 2.jpg, etc. And because they are from videos 1.jpg is like 2.jpg. In such a case, the object in the nth line of 1.jpg is the same as the nth line of 2.jpg in many situations. By doing this, it is easy to see that wrongly placed objects are grouped together as illustrated at 510, and it is very convenient for to move the whole wrongly placed group into the correct folder.

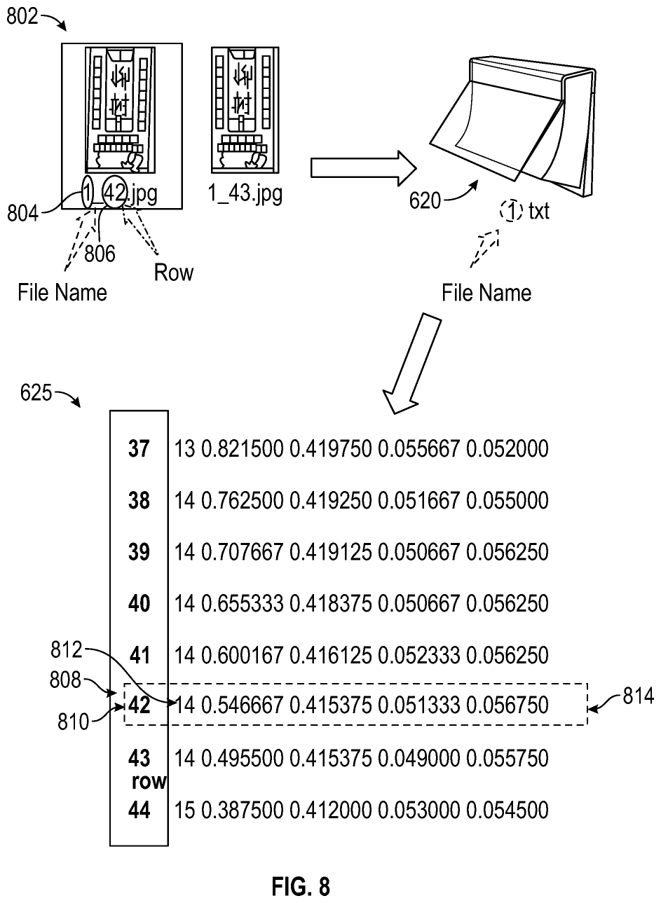

For example, FIG. 8 provides an exemplary file annotation 802. As illustrated, in the annotation file 802, each line has 5 numbers. The first is the index number of the item. The index number is used to find the item name in classes.txt file. The remaining 4 numbers give the information of the location of the bounding box in the image. When cropping the image, regenerator module can read each line and crop the item image from the original image using the bounding box information.

Next, at step 414 a regenerator module can correct the annotation files for the original images. This is done iteratively. As illustrated, the original annotation file contains several lines. Each line corresponds to an item's information: the name and the bounding box location. The bounding box location may be correct, but the name is not necessarily correct. If the name is not correct, the corresponding cropped image will be put into the wrong folder. In the review step, the reviewer can move the cropped image to the correct folder. The program module can then correct the annotation file, and will read all the images in all the folders. When it sees a cropped image in a folder, it can collect the following information: the original image name, the line number, and the correct item name which is the folder name. Then the module will replace the item name in the corresponding line of the corresponding annotation file until all the annotation files are correct.

Depending on the tasks (e.g., object detection, segmentation, 3D-object detection, 3D-segmentation), an object detection/segmentation neural network can be trained using the correct labelled data as further illustrated in FIG. 4B. For example, the YoloV3 framework can be used to train a Yolo object detection neural network. In other embodiments, other methods can be used.

In an embodiment illustrated in FIG. 4B, the method 450 begins at 452. At step 454 the object detection neural network can be trained with the original images and the corresponding annotation files. With this training, the object detection neural network can be trained to identify bounding boxes and the names of the items. This is understood to be the training procedure. With the training procedure complete, the trained neural network can identify where the bounding boxes are located and can identify the corresponding names for a set of images.

Furthermore, using the cropped images, a classification neural network can be trained at step 460 and used to assign a correct item name for the label added previously at step 462. For training object detection and image classification neural networks, a graphics processing unit (GPU) server and associated computer architecture can be use. In an embodiment, the classification neural network can be given a list of folders, where each folder contains a lot of cropped images. During the training procedure, the classification neural network will learn what image correspond to what name (folder's name). Once the training procedure is complete, a trained classification neural network is available. The trained classification neural network can be used to predict the name (e.g., folder name) for a cropped image. Then the classification neural network can be used to correct the folders of the cropped images by moving them to the correct folders.

Training a classification neural network can generally include: loading and normalizing the training and test datasets, defining a Convolutional Neural Network, defining a loss function, training the network on the training data, and testing the network on the test data.

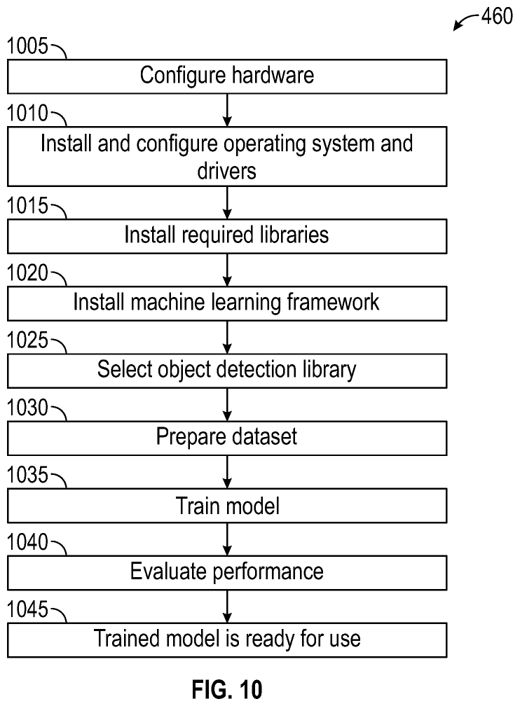

FIG. 10 illustrates a method for training an object detection and/or image classification neural network as shown at step 460, in accordance with the disclosed embodiments. It should be appreciated that the steps listed in method 1000 are exemplary and other training methods are possible.

At step 1005 a computer system can be set up and an associated GPU can be selected and configured for optimal performance. Likewise, computing hardware such as RAM and memory storage can be configured. Next at step 1010 an operating system and necessary drivers can be installed on the computer system. The drivers can be selected according to the GPU associated with the computer system.

At step 1015 any libraries or toolkits necessary for the neural network can be installed. In certain embodiments, this can include GPU libraries for the specific model associated with the neural network being trained (e.g., a deep learning neural network).

Next, at step 1020 a machine learning framework can be installed on the GPU based computer system. The deep learning framework can be selected to be compatible with the object detection task/the image classification task. Once the machine learning framework is installed, an object detection/an image classification library can be selected at step 1025. The object detection/the image classification library should be selected to match the machine learning framework. At step 1030, the training dataset can be prepared. This may required formatting to make the training dataset compatible with the selected library.

The model is now ready for training at step 1035. This step can include configuring the parameters associated with the model, and training the model for the desired application (e.g., object detection or image classification). Once the model is trained, at step 1040, the model performance can be checked to ensure the model's convergence is acceptable. The trained model is then ready for deployment at 1045.

Once the two neural networks are trained, the process can proceed to label the rest of the images. First, for any remaining image, the object detection neural network can identify where the bounding boxes are located and can identify the corresponding names at step 456. This information is saved as an annotation file, but this is just a pseudo annotation file because it needs to be checked by the reviewer. Thus, the pseudo labels for the remaining images are generated at step 416 of FIG. 4A.

The pseudo labels can then be used to check if there are any missing labels, and the existing labels can be adjusted if necessary at step 418. Once the pseudo labels are generated. The labelers can check if the bounding boxes have been labelled correctly. There is no need to check if the names of the bounding boxes are correct here. If there is any missing bounding box, the labeler will add one and assign its name to the first name of the items. Once the labelers finish their jobs, the reviewer will take over the task. The images can be cropped and place them in the corresponding folders. Then the classification neural network can be used to correct the folders of the cropped images by moving them to the correct folders at step 420.

Finally, the method includes manually checking the folders of the cropped images. If any of the cropped image are misplaced they can be moved to the correct folder. This is similar to step 412. At last, as shown in step 414, the annotation files for the original images are regenerated using the regenerator module. The method ends at 422.

The steps can then be repeated, with the training of the neural network step being repeatable to get a better neural network for future tasks. For example, imagine a 100,000 image set is provided. As an example, further assume 10,000 images are selected. The object detection neural network can be trained using these 10,000 image and the classification neural network can be trained using the corresponding cropped images from these 10,000 images. According to the disclosed method all 100,000 images can be labeled. The two neural networks are trained again using all the images and the corresponding cropped images respectively, to improve the neural networks.

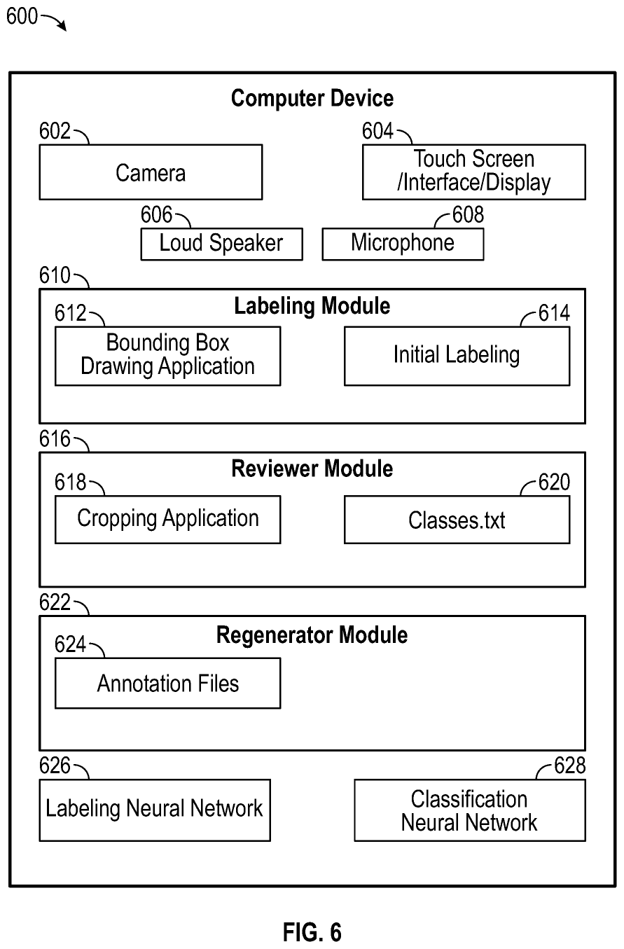

FIG. 6 illustrates aspects of a computer system 600 and associate computer system architecture, that can be used to realize the methods disclosed herein. It should be appreciated that the computer system 600 can comprise a computer system as illustrated in FIGS. 1-3. It should further be appreciated that the computer system can comprise multiple computer systems each configured to provide one or more functions described herein. The computer system 600 can comprise I/O components including, but not limited to, a camera 602, a touch screen interface/display 604, a loudspeaker 606, and a microphone 608. The I/O components may further include a keyboard, mouse, or other such input/output hardware.

The computer system 600 can include a labeling module 610, embodied as computer hardware or software. The labeling module 610 can include a bounding box drawing application 612 and an initial label module 614 which automatically assign the first item to the object and saves the result to an annotation file. The labeling module 610 can be used to achieve initial labeling steps, including but not limited to drawing a bounding box around objects in an image.

The computer system 600 can further include a reviewer module 616 comprising a cropping application 618. In certain embodiments, the cropping application can comprise a software program configured to crop the images and place them in the corresponding folder 620 using the names from a pre-defined file (e.g., “Classes.txt”).

The computer system 600 can further include a regenerator module 622. The regenerator module can comprise a software program configured to regenerate the annotation files 624, for the original images. FIG. 8 illustrates an example of this process. As illustrated in FIG. 8, the image data file 802 includes a file name 804 and row number 806. The image data file is sent to the corresponding folder 620. The regenerator module then creates the annotation file 624, with includes an entry 808 for the image data file 802, including the row 810, the index number 812, used to find the item name in the classes.txt file, and the location of the bounding box in the image represented by the final four numbers 814.

The computer system can further include a labeling neural network 626 and classification neural network 628.

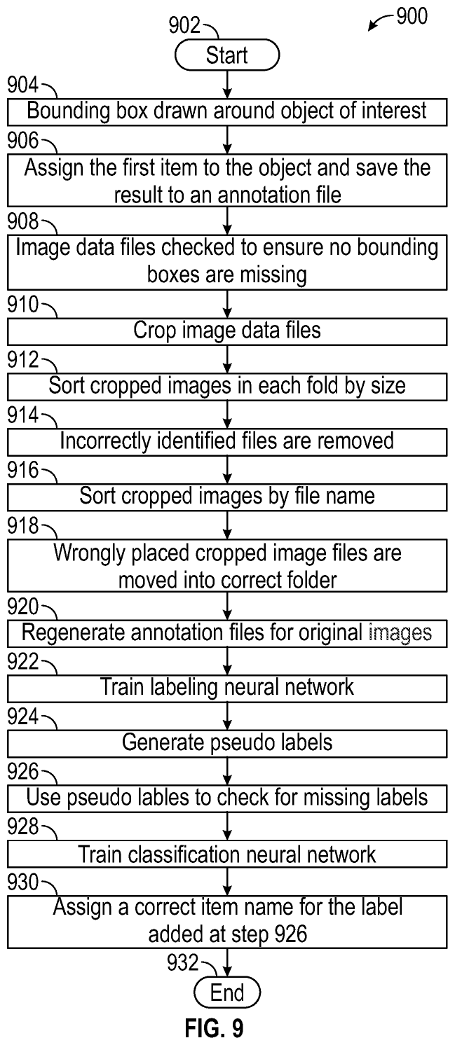

FIG. 9 illustrates an exemplary method implemented with the computer system as illustrated in FIG. 6. The method starts at 902.

At step 904 bounding boxes, which can comprise a standard bounding box/polygon/3D-bounding box/3D-polygon or the like can be drawn around the object of interest in each data file in the array of data files associated with the object detection task, using the bounding box drawing application 612.

At step 906, the computer system automatically assign the first item to the object and saves the result to an annotation file using the initial labeling application 614.

Next at step 908 every data file in the array of data files is checked to ensure that they are not missing a bounding box.

At step 910, the cropping application 618 can crop the objects of interest from the images and places them into corresponding folders 620. The corresponding folders can adopt a naming convention such that the folder names correspond with the name of the object of interest. The cropped images can be saved with the following exemplary naming convention [original name]-[line number in annotation file].jpg. This exemplary naming convention can be modified in other embodiments.

The cropped images in each folder are then sorted to make it easier to identify the misplaced cropped images. At step 912, the cropped image in each folder are sorted by the size of the cropped images. The size of the images is often fairly standard. In sorting by file size, it is easy to identify anomalous files which are either unexpectedly large or small. At step 914, images incorrectly identifying an object are removed.

Next at step 916, cropped images in each folder are sorted by the names. In many cases, the image data files may be videos and are therefore named consecutive; for example, as: “1.jpg,” “2.jpg,” etc. In such cases, it should be expected that the image data file 1.jpg is highly similar to the image data file 2.jpg. The object in the nth line of 1.jpg is therefore the same as the nth line of 2.jpg in most situations. In sorting by name, wrongly placed objects are easy to identify. At step 918, any wrongly placed cropped image file can be moved to into the correct folder.

At step 920, the regenerator module 622 is used to regenerate the annotation files for the original images. These annotation files are correct. The example of this process is illustrated in FIG. 8.

At step 922, depending on the task (e.g., object detection, segmentation, 3D-object detection, 3D-sementation), the labeling neural network 626 can be trained using the correct labelled data.

At step 924, pseudo labels for the remaining images are generated using the trained labeling neural network 626 which can be an object detection neural network.

At step 926, the pseudo labels are used to check if there is any labels are missing, and the existing labels are adjusted if necessary. As noted above, at this stage it does not matter if the item name is correct.

At step 928, using the sorted cropped images, a classification neural network 628 is trained. At step 930, the classification neural network 628 is then used to assign a correct item name for the label added at step 926. In some cases, manual adjustment may also be required (as in step 912-918). At the end the annotation files are generated in step 920.

It should be understood that the process can then be repeated from step 910 to step 920 as necessary for convergence. From this steps 922 and 924 can be repeated, as necessary to improve the labeling neural network 626 for future tasks. The method ends at 932.

The embodiments disclosed herein increase the labeling speed dramatically, increase the speed and accuracy of the labeling task, and make the training of labelers much easier.

It should be appreciated that variations of the above-disclosed and other features and functions, or alternatives thereof, may be desirably combined into many other different systems or applications.

In an embodiment, a system comprises a computer system, the computer system further comprising: at least one processor and/or at least one GPU(s), a graphical user interface, and a computer-usable medium embodying computer program code, the computer-usable medium capable of communicating with the at least one processor, the computer program code comprising instructions executable by the at least one processor and configured for: receiving a plurality of images, selecting an area of interest in at least one of the images, defined by a bounding box, cropping the selected areas from the images and storing the cropped images in folders, filtering incorrectly identified objects, generating pseudo labels for the remaining images, and assigning correct item names for the pseudo labels.

In an embodiment, the plurality of images comprises at least one of an image file, a video file, a video frame file.

In an embodiment of the system, the computer program code comprising instructions executable by the at least one processor is further configured for identifying any of the plurality of images missing bounding boxes.

In an embodiment of the system, the computer program code comprising instructions executable by the at least one processor is further configured for generating an annotation file corresponding to the plurality of images received.

In an embodiment of the system, the folders further comprise folder names corresponding to objects. In an embodiment of the system, the cropped images in the folders follow a file naming convention. In an embodiment, the file naming convention, comprises a file name of the type [ORIGINAL IMAGE NAME]-[LINE NUMBER IN ANNOTATION FILE].

In an embodiment of the system, the computer program code comprising instructions executable by the at least one processor is further configured for sorting cropped images by file size. In an embodiment of the system, the computer program code comprising instructions executable by the at least one processor is further configured for sorting cropped images by file name.

In an embodiment of the system, the computer program code comprising instructions executable by the at least one processor is further configured for training a labeling neural network, wherein the trained labeling neural network is used to generate the pseudo labels for the remaining images.

In an embodiment of the system, the computer program code comprising instructions executable by the at least one processor is further configured for training a classification neural network, wherein the trained classification neural network is used to assign the correct item names for the pseudo labels.

In another embodiment a method comprises: receiving a plurality of images, selecting an area of interest in at least one of the images defined by a bounding box, cropping the selected areas from the images and storing the cropped images in folders, filtering incorrectly identified objects, generating pseudo labels for the remaining images, and assigning correct item names for the pseudo labels.

In an embodiment, the method further comprises identifying any of the plurality of images missing bounding boxes.

In an embodiment, the method further comprises generating an annotation file corresponding to the plurality of images received.

In an embodiment, the method further comprises sorting cropped images by file size and removing cropped images from incorrect folders. In an embodiment, the method further comprises sorting cropped images by file name and removing cropped images from incorrect folders.

In an embodiment, the method further comprises training a labeling neural network, wherein the trained labeling neural network is used to generate the pseudo labels for the remaining images. In an embodiment, the method further comprises training a classification neural network, wherein the trained classification neural network is used to assign the correct item names for the pseudo labels. GPU servers can be used to train neural networks.

In an embodiment, a computer system can be set up and associated GPUs can be selected and configured for optimal performance. Likewise, computing hardware such as RAM and memory storage can be configured. An operating system and necessary drivers can be installed on the computer system. The drivers can be selected according to the GPU associated with the computer system. Any libraries or toolkits necessary for the neural network can be installed. In certain embodiments, this can include GPU libraries for the specific model associated with the neural network being trained (e.g., a deep learning neural network). Next, a machine learning framework can be installed on the GPU based computer system. The deep learning framework can be selected to be compatible with the object detection task/the image classification task. Once the machine learning framework is installed, an object detection/an image classification library can be selected. The object detection/the image classification library should be selected to match the machine learning framework. The training dataset can be prepared. This may require formatting to make the training dataset compatible with the selected library. The model is now ready for training. This step can include configuring the parameters associated with the model, and training the model for the desired application (e.g., object detection or image classification). Once the model is trained, the model performance can be checked to ensure the model's convergence is acceptable. The trained model is then ready for deployment.

In another embodiment a system comprises a computer system, the computer system further comprising: at least one processor, a graphical user interface, and a computer-usable medium embodying computer program code, the computer-usable medium capable of communicating with the at least one processor, the computer program code comprising instructions executable by the at least one processor and configured for: receiving a plurality of images, selecting an area of interest in at least one of the images defined by a bounding box, cropping the selected areas from the images and storing the cropped images in folders, generating an annotation file corresponding to the plurality of images received, sorting cropped images by file size, removing cropped images from incorrect folders, sorting cropped images by file name, removing cropped images from incorrect folders, generating pseudo labels for the remaining images using a labeling neural network, and assigning correct item names for the pseudo labels using a classification neural network.

In an embodiment of the system, the computer program code comprising instructions executable by the at least one processor is further configured for training a labeling neural network, wherein the trained labeling neural network is used to generate the pseudo labels for the remaining images and training a classification neural network, wherein the trained classification neural network is used to assign the correct item names for the pseudo labels.

It should be understood that various presently unforeseen or unanticipated alternatives, modifications, variations, or improvements therein may be subsequently made by those skilled in the art which are also intended to be encompassed by the following claims.

What is claimed is:

1. A system comprising:
a computer system, the computer system further comprising:
at least one processor;
a graphical user interface; and
a computer-usable medium embodying computer program code, the computer-usable medium capable of communicating with the at least one processor, the computer program code comprising instructions executable by the at least one processor and configured for:
receiving a plurality of images;
selecting an area of interest in at least one of the plurality of images, defined by a bounding box;
cropping the selected areas of interest from the images and storing the cropped images in folders;
filtering incorrectly identified objects;
generating pseudo labels for the remaining images; and
assigning correct item names for the pseudo labels.

2. The system of claim 1 where the plurality of images comprises at least one of:
an image file;
a video file; and
a video frame file.

3. The system of claim 1 wherein the computer program code comprising instructions executable by the at least one processor is further configured for:
identifying any of the plurality of images missing bounding boxes.

4. The system of claim 1 wherein the computer program code comprising instructions executable by the at least one processor is further configured for:
generating an annotation file corresponding to the plurality of images received.

5. The system of claim 1 wherein the folders further comprise:
folder names corresponding to objects.

6. The system of claim 5 wherein the cropped images in the folders follow a file naming convention.

7. The system of claim 6 wherein the file naming convention, comprises:
a file name of a type [ORIGINAL IMAGE NAME]-[LINE NUMBER IN ANNOTATION FILE].

8. The system of claim 1 wherein the computer program code comprising instructions executable by the at least one processor is further configured for:
sorting cropped images by file size.

9. The system of claim 1 wherein the computer program code comprising instructions executable by the at least one processor is further configured for:
sorting cropped images by file name.

10. The system of claim 1 wherein the computer program code comprising instructions executable by the at least one processor is further configured for:
training a labeling neural network, wherein the trained labeling neural network is used to generate the pseudo labels for the remaining images.

11. The system of claim 1 wherein the computer program code comprising instructions executable by the at least one processor is further configured for:
training a classification neural network, wherein the trained classification neural network is used to assign the correct item names for the pseudo labels.

12. A method comprising:
receiving a plurality of images;
selecting an area of interest in at least one of the images defined by a bounding box;
cropping the selected areas from the images and storing the cropped images in folders;
filtering incorrectly identified objects;
generating pseudo labels for the remaining images; and
assigning correct item names for the pseudo labels.

13. The method of claim 12 further comprising:
identifying any of the plurality of images missing bounding boxes.

14. The method of claim 12 further comprising:
generating an annotation file corresponding to the plurality of images received.

15. The method of claim 12 further comprising:
sorting cropped images by file size; and
removing cropped images from incorrect folders.

16. The method of claim 12 further comprising:
sorting cropped images by file name; and
removing cropped images from incorrect folders.

17. The method of claim 12 further comprising:
training a labeling neural network, wherein the trained labeling neural network is used to generate the pseudo labels for the remaining images.

18. The method of claim 12 further comprising:
training a classification neural network, wherein the trained classification neural network is used to assign the correct item names for the pseudo labels.

19. A system comprising:
a computer system, the computer system further comprising:
at least one processor and at least one GPU;
a graphical user interface; and
a computer-usable medium embodying computer program code, the computer-usable medium capable of communicating with the at least one processor, the computer program code comprising instructions executable by the at least one processor and configured for:
receiving a plurality of images;
selecting an area of interest in at least one of the images defined by a bounding box;
cropping the selected areas from the images and storing the cropped images in folders;
generating an annotation file corresponding to the plurality of images received sorting cropped images by file size;
removing cropped images from incorrect folders;
sorting cropped images by file name;
removing cropped images from incorrect folders;
generating pseudo labels for the remaining images using a labeling neural network; and
assigning correct item names for the pseudo labels using a classification neural network.

20. The system of claim 19 wherein the computer program code comprising instructions executable by the at least one processor is further configured for:
training a labeling neural network, wherein the trained labeling neural network is used to generate the pseudo labels for the remaining images; and
training a classification neural network, wherein the trained classification neural network is used to assign the correct item names for the pseudo labels.
